(19) United States
(12) Patent Application Publication
(10) Pub. No.: US 2011/0046243 A1
(43) Pub. Date: Feb. 24, 2011

(54) MACHINE AND METHOD FOR EMULSIFICATION

(75) Inventors: Yuzuru ITO, Tokyo (JP); Hajime Kato, Tokyo (JP); Syuuichi Mori, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Plant Technologies, Ltd.

(21) Appl. No.: 12/845,790

(22) Filed: Jul. 29, 2010

(30) Foreign Application Priority Data
Aug. 24, 2009 (JP) 2009-192991

(51) Int. Cl. B01J 13/00; B01F 5/08

(52) U.S. Cl. 516/98; 366/134

(57) ABSTRACT

A multi-parallel processing emulsification machine excellent in ease of priming and cleaning the interior of flow paths, capable of also coping with a liquid that precipitates is provided. A component through which a continuous phase to be the solvent of emulsion flows is stacked over a component through which a disperse phase to be the solute of the emulsion flows. Further, a component through which the produced emulsion flows is stacked thereover to form a microfluidic device for emulsification. When they are stacked together, multiple minute cross-shaped globule production portions are formed and in these globule production portions, the disperse phase flows from downward to upward. The continuous phase merges into them from left and right to form a sheath flow in which the continuous phase encircles the circumference of the disperse phase. In the sheath flow, the disperse phase is divided and turned into globules by a difference in velocity of flow between the continuous phase and the disperse phase. Thus an emulsion is produced and flows upward through the globule production flow paths. All the minute flow paths are so structured that they are open upward. As a result, fine particles in liquid are less prone to precipitate and air can be easily exhausted.

### BACKGROUND OF THE INVENTION

The present invention relates to a machine and a method for emulsification wherein different kinds of liquids respectively supplied from multiple liquid supply openings are guided into minute flow paths and these liquids are emulsified in the minute flow paths to obtain a milky liquid. In this liquid, or an emulsion, some liquid is dispersed as globules in another liquid.

As a conventional method for emulsifying liquid-liquid, batch production methods are known. In these methods, raw materials and a surface active agent are charged into a large vessel and a large quantity of emulsion is produced at a time using a rotating/agitating mechanism, such as a homogenizer. The emulsion refers to a milky fluid of liquid/liquid system obtained by: adding a surface active agent (emulsifier) to two incompatible liquids, such as water and oil; and carrying out mechanical operation, such as agitation, to uniformly disperse oil droplets in water (or water droplets in oil). However, since in this batch production, emulsification is carried out in a large vessel, various problems may arise. Examples of such problems include that: it is difficult to maintain uniform temperature in the vessel and this produces a difference in viscosity; and shearing force applied during rotation/agitation is not uniformly transmitted to the entire liquids. Because of the influence of these problems, the produced emulsion is not uniform in particle diameter and the particle diameter has a distribution; therefore, it may be required to carry out classification to sort out only those of a desired particle diameter after agitation. It is said that rotation/agitation must be carried out for several minutes to several tens of minutes to stabilize a particle diameter distribution to a certain value and an efficient production method has been desired.

As a method for solving the above problems, in recent years, attention has been attracted to microfluidic devices that carry out emulsification in a minute flow path of several μm to several hundreds of μm or so. Microfluidic devices that carry out emulsification in a minute flow path are capable of obtaining uniform emulsion by taking the following measure: the temperature in flow path is kept constant to control and keep the viscosity of liquid constant; and, in addition, shearing force applied to the liquid in the flow path is made uniform to divide the liquid into globules equal in diameter.

Specifically, Japanese Unexamined Patent Publication No. 2007-216206 discloses a method of obtaining emulsion by taking the following measure: after two different kinds of liquids are merged into one flow, it is passed through a flow path having multiple fine convex structures; and disturbance is thereby induced in the interface between the two liquids to divide the liquids. Japanese Unexamined Patent Publication No. 2004-359822 discloses a method of obtaining emulsion by taking the following measure: flow paths are formed in a circular substrate so that two different kinds of liquids are orthogonal to each other; and one liquid is caused to laterally shear the other liquid so that it washes away the other liquid.

The technologies described in Japanese Unexamined Patent Publication No. 2007-216206 and Japanese Unexamined Patent Publication No. 2004-359822 make good use of the characteristics of microfluid and are superior to conventional batch methods in the production of emulsion. However, if these methods are extendedly applied to actual productive use, it is expected that a problem will arise in the following: uniform liquid sending for uniformly supplying liquid to multiple minute flow paths and cleaning for removing dirt and the like from these flow paths. The following is a description of the reason for this:

In a microfluidic device, usually, liquid is sent into a minute flow path of several μm to several hundreds of μm or so; therefore, the throughput per flow path is very low. For this reason, to provide a throughput at a level applicable to actual productive use, a structure designated as numbering-up in which multiple flow paths are provided in parallel is required. Both in Japanese Unexamined Patent Publication No. 2007-216206 and in Japanese Unexamined Patent Publication No. 2004-359822, it is important to fulfill functions that the flow of liquid is a laminar flow. The technologies described in these documents are equivalent to ordinary microfluidic devices in this regard. In the numbering-up structure, it is important how liquid should be uniformly sent to each flow path and for this purpose, it is required to carry out priming to remove air (air bubbles) in the minute flow paths at start of liquid sending.

The reason for this is as described below. Microfluidic devices using minute flow paths are higher in the ratio of the circumference of the section of a flow path to the sectional area of the flow path than ordinary macro flow paths of several mm or above. Thus the influence of interfacial tension is increased. If air remains in a flow path, therefore, and it is difficult to remove air bubbles sticking to a wall surface. This results in a problem that liquid is not sent to some flow path or the like and the machine does not correctly function anymore. Especially, in a numbering-up structure having multiple flow paths in parallel, liquid is routed to a flow path lower in flow path resistance where air has not entered and it is more difficult to remove air bubbles.

On the other hand, there are multiple convexes in a minute flow path in the technology described in Japanese Unexamined Patent Publication No. 2007-216206; therefore, it is difficult to remove air bubbles accumulated between convexes. The method described in Japanese Unexamined Patent Publication No. 2004-359822 involves a structure in which liquid supplied from outside equipment is directly sent to a branched flow path and air in the flow path cannot escape. This structure poses a problem that air is prone to remain in a branched area and a corner and an edge of the flow path during priming.

In actual emulsion production, such a product as ink may be handled. In such a product, fine particles high in specific gravity are contained in liquid and precipitation occurs with long-time continuous running or the passage of time. In this case, to prevent choking of a minute flow path and degradation in the quality of a product due to dirt in a flow path or precipitation, periodical cleansing is also required. To prevent the operating time of the equipment from being shortened in such a case, in-line cleaning in which cleaning can be carried out in a short time is desirable. With the above-mentioned flow path shape that makes priming difficult, however, it is also difficult to substitute the content in a flow path by cleaning liquid during cleaning. Especially, in a flow path having convexes like that described in Japanese Unexamined Patent Publication No. 2007-216206, a problem of difficulty in cleaning a corner at the base of each convex also arises.

### BRIEF SUMMARY OF THE INVENTION

In consideration of the disadvantages associated with the above conventional technologies, it is an object of the invention to provide a multi-parallel processing emulsification machine that can also cope with liquid with which precipitation is prone to occur in flow paths and is excellent in ease of priming and cleaning the interior of the flow paths.

To achieve the above object, the invention is embodied as an emulsification machine equipped with a microfluidic device for emulsification. When two different kinds of liquids are sent, the microfluidic device forms a sheath flow in a minute flow path. The sheath flow is obtained by encircling a disperse phase as a first liquid with a continuous phase as a second liquid. The microfluidic device divides the disperse phase by a velocity difference between the disperse phase and the continuous phase and turns it into globules to obtain emulsion. In this emulsification machine, the microfluidic device for emulsification includes: multiple disperse phase processing flow paths for letting the disperse phase through; multiple continuous phase processing flow paths for letting the continuous phase through; multiple globule production portions that merge liquids of the disperse phase and the continuous phase at areas where both the processing flow paths intersect with each other to produce emulsion globules; a disperse phase main flow path that is branched to each of the disperse phase processing flow paths and sends liquid; a continuous phase main flow path that is branched to each of the continuous phase processing flow paths and sends liquid; and an emulsion main flow path for merging globules produced and sent by the globule production portions and sending them to the outside. The emulsification machine is further equipped with: a pump for sending each liquid or cleaning liquid to each of the main flow paths; a main flow path opening/closing valve provided at the exhaust opening of each of the main flow paths; a product/waste liquid change-over valve for switching liquid sent out from the emulsion main flow path between the product side and the waste liquid side; a monitoring device that monitors the state of emulsion; a pressure sensor that monitors the internal pressure of the machine; and a control unit that controls each of the above elements based on signals form the monitoring device and the pressure sensor.

In the emulsification machine, according to the invention, the globule production portions are disposed so that the disperse phase processing flow paths let the disperse phase flow from downward to upward. The continuous phase processing flow paths are so disposed that they laterally merge into the disperse phase. The globule production portions are provided with a globule production flow path that lets globules after merging flow upward to send the liquid to the emulsion main flow path.

In the emulsification machine, according to the invention, the microfluidic device for emulsification includes: a disperse phase distribution portion having multiple upward-facing disperse phase processing flow paths; a continuous phase distribution portion having multiple laterally-facing continuous phase processing flow paths and upward-facing globule production flow paths continuing to these flow paths and stacked over the disperse phase distribution portion; and a liquid discharge portion having the emulsion main flow path and stacked over the continuous phase distribution portion. By tacking these portions together, the globule production portions are formed in the stacked portion of the disperse phase distribution portion and the continuous phase distribution portion; and the disperse phase processing flow paths, continuous phase processing flow paths, and globule production flow paths communicate with these globule production portions.

In the emulsification machine, according to the invention, the following measure is taken in the globule production portions: the dimensions of the after-merging globule production flow paths are equal to or larger than the dimensions of the before-merging disperse phase processing flow paths; and the inlet of each after-merging globule production flow path is provided with a funnel-shaped chamfered structure.

In the emulsification machine, according to the invention, the continuous phase main flow path is disposed in a meandering shape with the disperse phase processing flow path sandwiched from both sides so that liquid can be sent from the continuous phase processing flow paths to the disperse phase processing flow paths from both sides; and the straight portions at both ends of the meandering shape are wider than the straight portions in the center of the meandering shape.

In the emulsification machine, according to the invention, the pumps and each valve are controlled by the control unit so that the following is implemented to carry out priming to remove air in each flow path and cleaning to remove dirt, such as precipitate: first, the main flow path opening/closing valves are opened and the setting of the product/waste liquid change-over valve is changed to the waste liquid side; predetermined liquids are supplied to the respective main flow paths by the pumps; subsequently, the main flow path opening/closing valves are closed and predetermined liquids are supplied to the processing flow paths and the globule production portions by the pumps; and subsequently, the outlet flow path change-over valve is opened to send a predetermined liquid to the emulsion main flow path by the pump.

In the emulsification machine, according to the invention, the globule production portions further include the following flow paths in addition to the continuous phase processing flow paths intersecting with the disperse phase processing flow paths: second continuous phase processing flow paths intersecting with the globule production flow paths. The circumference of a sheath flow formed in merging areas between the disperse phase processing flow paths and the continuous phase processing flow paths is encircled with the continuous phase from the second continuous phase processing flow paths to form a multilayer sheath flow and multilayer emulsion is thereby produced.

The emulsification machine uses a microfluidic device for emulsification obtained by: providing a component provided with a disperse phase main flow path through which a disperse phase to be the solute of emulsion flows on the lower side; stacking a component provided with a continuous phase main flow path through which a continuous phase to be the solvent of the emulsion flows thereover; and further stacking a component provided with an emulsion main flow path through which the produced emulsion flows thereover. Multiple minute flow paths are branched from these main flow paths and when these components are stacked together, multiple minute cross-shaped globule production flow paths are formed in parallel with a section of the stack.

Each main flow path has a sufficiently large sectional area as compared with the globule production flow path portion. Each main flow path is so structured that there is no branch other than the minute globule production flow paths and it has a different outlet to outside the device not by way of the globule production flow paths. Since there is no branch at the same level in flow path resistance and sent liquid carries away air and residual liquid and fills the interior of each flow path without fail, each main flow path is excellent in priming and cleaning properties. In addition, each main flow path functions as a buffer for uniformly supplying liquid to the multiple globule production flow paths.

In the globule production flow paths, a disperse phase flows from downward to upward and a continuous phase merges into it from left and right to form a sheath flow in which the circumference of the disperse phase is encircled with the continuous phase. In the sheath flow, emulsion is produced by the disperse phase being divided and turned into globules by a difference in velocity of flow between the continuous phase and the disperse phase and it flows to above the globule production flow paths. In each globule production flow path, a stable sheath flow is formed by the continuous phase and the disperse phase uniformly sent through the main flow paths and emulsion globules uniform in diameter can be produced. In addition, the upward open structure of all the minute flow paths implements the following: even when a liquid in which fine particles precipitate is used, precipitation is less prone to occur and minute flow paths are less prone to be choked and thus stable emulsion can be produced.

In addition, priming and in-line cleaning can be reliably carried out in all the flow paths in the microfluidic device for emulsification by performing the following operation in three stages. That is, the interior of main flow paths having a larger sectional area is primed and cleaned by controlling a valve provided on the outlet side of the device. Therafter, the interior of the globule production flow paths having a smaller sectional area is primed and cleaned. Last, the emulsion main flow path is primed and cleaned.

### BRIEF DESCRIPTION OF THE SEVERAL VIEWS OF THE DRAWING

FIG. 1 is a block diagram of an emulsification machine in an embodiment of the invention;

FIG. 2 is an exploded perspective view of a microfluidic device for emulsification provided in the emulsification machine illustrated in FIG. 1;

FIG. 3 is a top view of a disperse phase distribution portion, partially illustrating the microfluidic device for emulsification illustrated in FIG. 2;

FIG. 4 is a top view of a continuous phase distribution portion, partially illustrating the microfluidic device for emulsification illustrated in FIG. 2;

FIG. 5 is a top view of a liquid discharge portion, partially illustrating the microfluidic device for emulsification illustrated in FIG. 2;

FIG. 6 is a sectional view taken along line A-A of FIG. 2, partially illustrating the microfluidic device for emulsification illustrated in FIG. 2;

FIG. 7 is an enlarged sectional view of the globule production portion in FIG. 6, partially illustrating the microfluidic device for emulsification illustrated in FIG. 2; and

FIG. 8 is a drawing illustrating the production of multilayer emulsion.

### DETAILED DESCRIPTION OF THE INVENTION

Hereafter, description will be given to an embodiment illustrated in the drawings. In the these drawings, the flow of a disperse phase turned into globules in emulsion is indicated by an arrow of an alternate long and two short dashes line; the flow of a continuous phase to be the solvent of the emulsion is indicated by an arrow of a solid line; the flow of produced emulsion is indicated by an arrow of a broken line; and the other flows of air, cleaning liquid, waste liquid, and the like are indicated by an arrow of a dotted line.

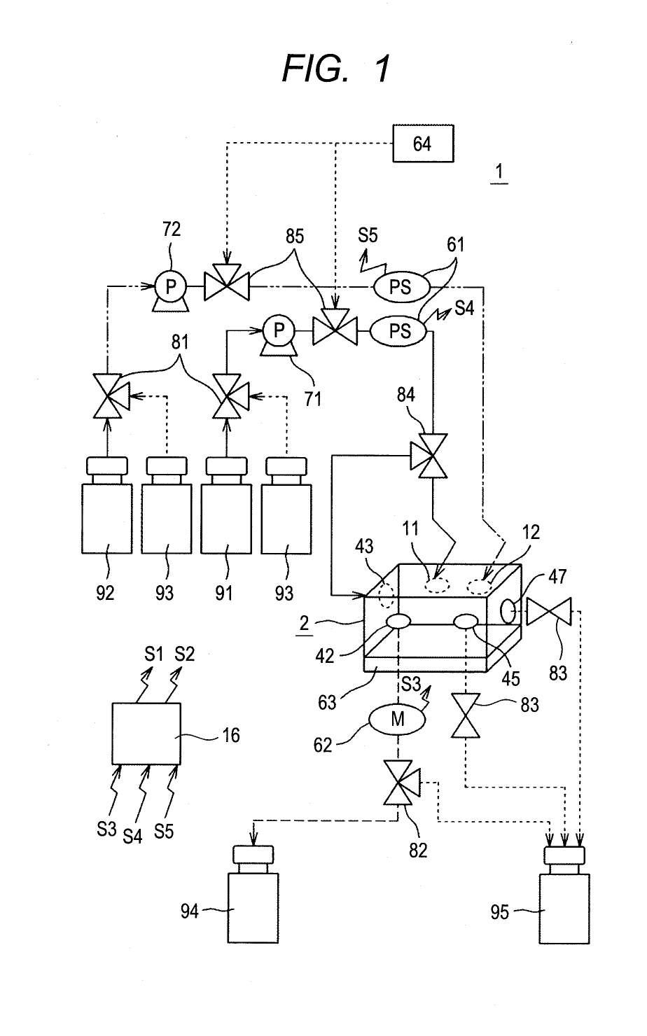

FIG. 1 illustrates the configuration of the emulsification machine 1 in an embodiment of the invention. In the description of this embodiment, emulsification in which the following is implemented will be taken as an example: a mixture of water and a surface active agent is used for a continuous phase; food oil is used as a disperse phase; and O/W (oil in water)-type emulsion obtained by dispersing oil droplets in water is produced.

In the emulsification machine 1, the continuous phase to be the solvent of the emulsion is stored in a continuous phase tank 91 and the disperse phase to be the solute is stored in a disperse phase tank 92. Cleaning liquids for cleaning continuous phase flow paths and disperse phase flow paths are stored in two cleaning liquid tanks 93. When the continuous phase and the disperse phase are identical in the type of cleaning liquid, it is acceptable to provide only a single cleaning liquid tank 93.

The liquids stored in the respective tanks are sent to a microfluidic device 2 for emulsification by way of pressure sensors 61 by a continuous phase pump 71 and a disperse phase pump 72. When each pressure sensor 61 detects the ingress of foreign matter into a minute flow path in the microfluidic device 2 for emulsification or a pressure anomaly due to choking of a flow path by precipitate, it brings a pump into emergency stop. There is no special limitation on the configuration of each pump; however, those like a syringe (plunger) pump in which the quantity of sent liquid does not vary so much with respect to pressure fluctuation on the secondary side are desirable. Reference numeral 16 denotes a control unit that receives detection signals S3 to S5 from the pressure sensors 61 and a monitoring device 62 and outputs control signals S1, S2 to control each pump and each valve.

In the microfluidic device 2 for emulsification, the continuous phase and the disperse phase merge into one and emulsion is produced as described later. The produced emulsion is discharged from the microfluidic device 2 for emulsification and goes through the monitoring device 62 for monitoring globule diameter or particle size diameter and is stored in a product tank 94. For the monitoring device 62, a particle size diameter detector that observes the particle size of emulsion or the like is used; however, it is desirable to use a not-contact measurement type that does not have influence on the state of emulsion. For this purpose, a light transmission method utilizing the intensity of the amount of transmitted light or a measuring instrument of laser diffraction type is used.

As mentioned above, the emulsification machine 1 illustrated in FIG. 1 is capable of continuously producing emulsion just by sending liquids to the microfluidic device 2 for emulsification. It is unnecessary to separately provide such a liquid dispensing or agitating mechanism as in batch production and this makes it possible to downsize and simplify the machine. Aside from the foregoing, the emulsification machine 1 includes the following as mechanisms for the priming and cleaning described later: a waste liquid tank 95; a valve for changing flow paths; an ultrasonic generator 63 for the enhancement of cleaning effect; an air source 64 for purging residual liquid in the machine piping; and the like.

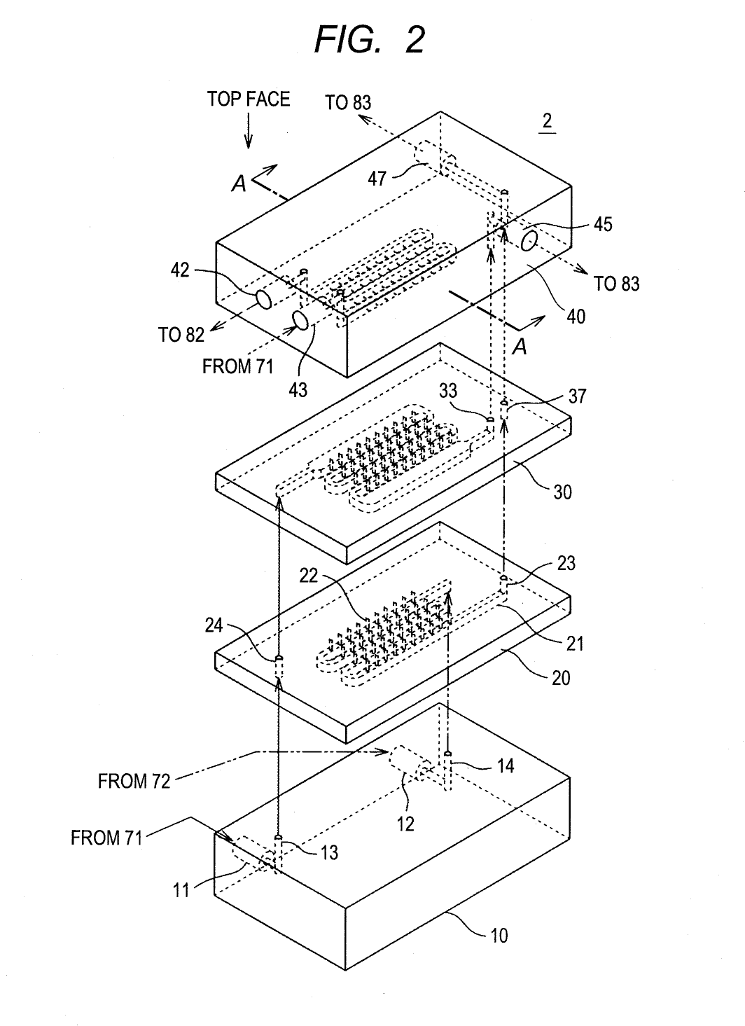

FIG. 2 illustrates the configuration of the microfluidic device 2 for emulsification. The microfluidic device 2 for emulsification is comprised of four stacked components: a liquid introduction portion 10, a disperse phase distribution portion 20, a continuous phase distribution portion 30, and a liquid discharge portion 40. Minute flow paths for producing emulsion are formed by stacking together these components in order. To prevent liquid from leaking out of a flow path, it is required to bring the components into tight contact with one another. There is no special limitation on the material of each component. When each component is fabricated of resin material, for example, adhesive may be used to bring the components into tight contact with one another. When they are fabricated of metal material, the following procedure may be taken: contact surfaces are polished and pressure is applied from above and below and the components are brought into tight contact with one another by metal touch. When ease of disassembly and the like are taken into account, it is desirable to adopt the following method: each component is provided with packing grooves and bolt holes, neither of which is shown in the drawing; rubber packing is placed between components; and the entire components are fastened together by bolts penetrating all the components.

The following is a description of effects of the structure in which the four components are stacked together. The proper diameter of the disperse phase processing flow paths 22 and the globule production flow paths 32 differs depending on the property (viscosity and the like) of material or a desired diameter or quantity of globules; therefore, the combination of the components can be changed as required by preparing multiple kinds of the disperse phase distribution portion 20 or the continuous phase distribution portion 30 different in diameter. Some examples of usage of the stack structure will be taken. When the diameter of globules is controlled by flow control and it is desired to get out of the control range of the diameter, it can be coped with by using disperse phase processing flow paths 22 and globule production flow paths 32 different in diameter. Further, the liquid introduction portion 10 and the liquid discharge portion 40 that are components connected with the outside are separate from each other. Therefore, they can be easily replaced with a component having a connection method (the size of screws and the like) matched with external equipment to be connected and they can be connected to various liquid sending systems.

The following is a description of effects of the disassemblable stack structure. If a disperse phase processing flow path 22 or a globule production flow path 32 that is a minute nozzle is choked or damaged, it can be quickly recovered by replacing the relevant component with a new one. At the time of machine maintenance or the like, dirt and precipitate can be more reliably removed than by in-line cleaning by taking the following measure: the microfluidic device is disassembled into individual components and each component is immersed in cleaning liquid and subjected to ultrasonic cleaning.

Hereafter, detailed description will be given to each component. The liquid introduction portion 10 is provided with a continuous phase port 11 and a disperse phase port 12. The continuous phase port 11 is connected to the continuous phase pump 71 and the disperse phase port 12 is connected to the disperse phase pump 72 respectively by pipes and joints, neither of which is shown in the drawing. They discharge raw material and cleaning liquid sent by pumps from a continuous phase supply opening 13 and a disperse phase supply opening 14 into the disperse phase distribution portion 20 positioned in the immediately upper layer.

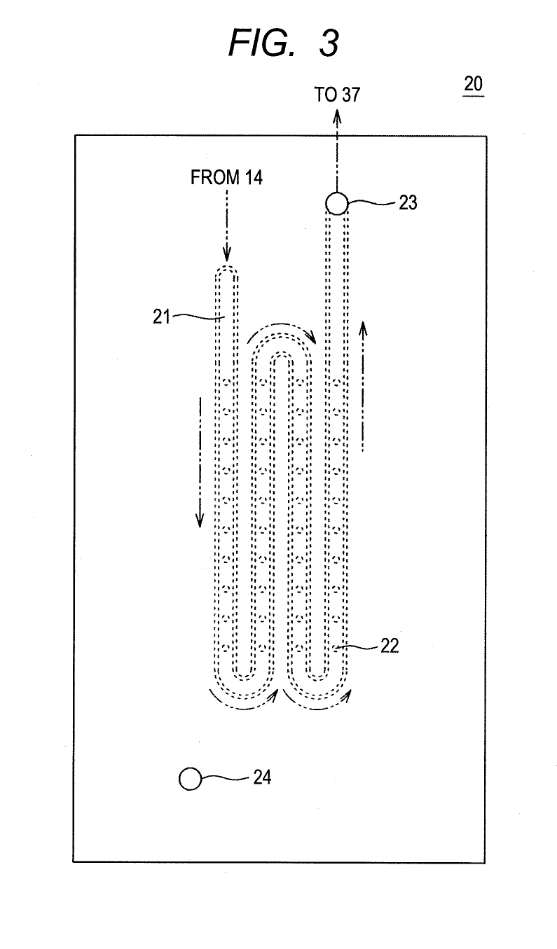

FIG. 3 is a top view of the disperse phase distribution portion 20. The disperse phase distribution portion 20 has a meandering disperse phase main flow path 21 on the surface (under surface) in contact with the liquid introduction portion 10. The disperse phase main flow path 21 originates directly above the disperse phase supply opening 14 and meanders and goes through all the minute disperse phase processing flow paths 22. Then it runs into a disperse phase discharge opening 23 which is a hole connecting to the continuous phase distribution portion 30. The disperse phase discharge opening 23 has the same radial dimensions as those of the disperse phase main flow path 21.

The disperse phase processing flow paths 22 are minute holes (nozzle-like openings) extended from the disperse phase main flow path 21 to the top face of the disperse phase distribution portion 20. The drawing illustrates a case where 40 flow paths, that is, 10 flow paths×4 rows, are provided. The number of required nozzles is increased with increase in the desired quantity of produced emulsion; therefore, the number of the disperse phase processing flow paths 22 is adjusted by appropriately adjusting the number of rows and the number of nozzles per row with the overall size of the microfluidic device 2 for emulsification taken into account. The diameter of the disperse phase processing flow paths 22 is appropriately adjusted in accordance with the desired globule diameter of emulsion. It is desirable that the diameter of the disperse phase processing flow paths 22 should be equal to a desired globule diameter or should be appropriately twice the desired globule diameter at most. The disperse phase main flow path 21 undertakes a role of a buffer for uniformly supplying liquid to the multiple disperse phase processing flow paths 22; therefore, it must be a sufficiently large flow path lower in pressure loss than the disperse phase processing flow paths 22.

As described later, the microfluidic device 2 for emulsification in this embodiment controls globule diameter by the flow ratio between a continuous phase and a disperse phase. To obtain uniform emulsion, therefore, it is required to make uniform the quantity of flow discharged from each disperse phase processing flow path 22. For this purpose, the size of the disperse phase main flow path 21 is determined so that the following is implemented: the flow rate error from nozzle to nozzle is suppressed to several % or below according to the number or flow path resistance of the disperse phase processing flow paths 22. To suppress the flow rate error from nozzle to nozzle to several % or below, it is required to set the size of the main flow path so that the following ratio holds: main flow path resistance:nozzle portion (processing flow path) resistance is 1:10000 to 100000 or so. For this reason, it is desirable to take the following measure, though depending on the number of the disperse phase processing flow paths: when the diameter of each disperse phase processing flow path 22 is 50 μm, for example, the main flow path 21 is configured as a rectangle 1 mm or above on a side.

In this embodiment, the disperse phase main flow path 21 is formed in a meandering shape. However, any other shape, such as straight shape or spiral shape, may be adopted as long as the following conditions hold: the disperse phase main flow path is far lower in flow path resistance than the nozzle portions; it is in the shape of one single consecutive body without a branch at the same level in flow path resistance as the nozzle portions; and it has a smooth structure without projections or depressions. A continuous phase passage opening 24 open in a position away from the disperse phase main flow path 21 is positioned directly above the continuous phase supply opening 13. It provides a flow path when liquid discharged from the continuous phase supply opening 13 is sent to the continuous phase distribution portion 30.

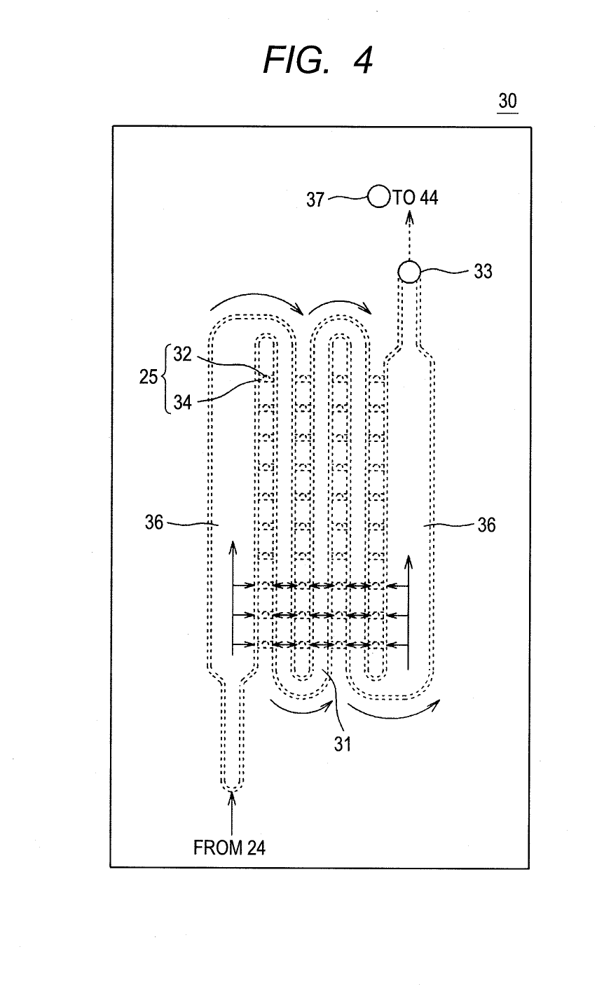

FIG. 4 is a top view of the continuous phase distribution portion 30. The continuous phase distribution portion 30 has a meandering continuous phase main flow path 31 on the surface (under surface) in contact with the disperse phase distribution portion 20. The continuous phase main flow path 31 originates directly above the continuous phase passage opening 24 and meanders so that all the globule production flow paths (nozzles) 32 (described later) are sandwiched from left and right. It then runs into a continuous phase discharge opening 33 that is a hole continues to the liquid discharge portion 40. (Refer to FIG. 2.) The continuous phase discharge opening 33 has the same radial dimensions as those of the continuous phase main flow path 31. As flow paths that connect together two parts of the continuous phase main flow path 31 sandwiching the globule production flow paths 32 from left and right, minute continuous phase processing flow paths 34 are provided. The continuous phase processing flow paths 34 are smaller in dimensions, such as groove depth, than the continuous phase main flow path 31 as a buffer. It is so formed that the liquid filled in the continuous phase main flow path 31 uniformly reaches the globule production flow paths 32 from two directions, left and right, as illustrated by solid lines in the drawing.

The globule production flow paths 32 are minute holes positioned directly above the disperse phase processing flow paths 22 positioned in the immediately lower layer and extended from the continuous phase processing flow paths 34 to the top face of the continuous phase distribution portion 30. The same number of the globule production flow paths 32 as that of the disperse phase processing flow paths 22 are formed. In the globule production flow paths 32, as described later, the continuous phase flowing in from left and right and the disperse phase discharged from the opposite disperse phase processing flow paths 22 are merged to form a sheath flow 50 (describe later). If the globule production flow paths 32 on the receiving side are smaller in diameter than the disperse phase processing flow paths 22 on the discharge side at this time, the inside diameter is reduced and the stability of sheath flow 50 formation is degraded. To cope with this, it is desirable that the diameter of the globule production flow paths 32 should be equal to or larger than the diameter of the disperse phase processing flow paths 22.

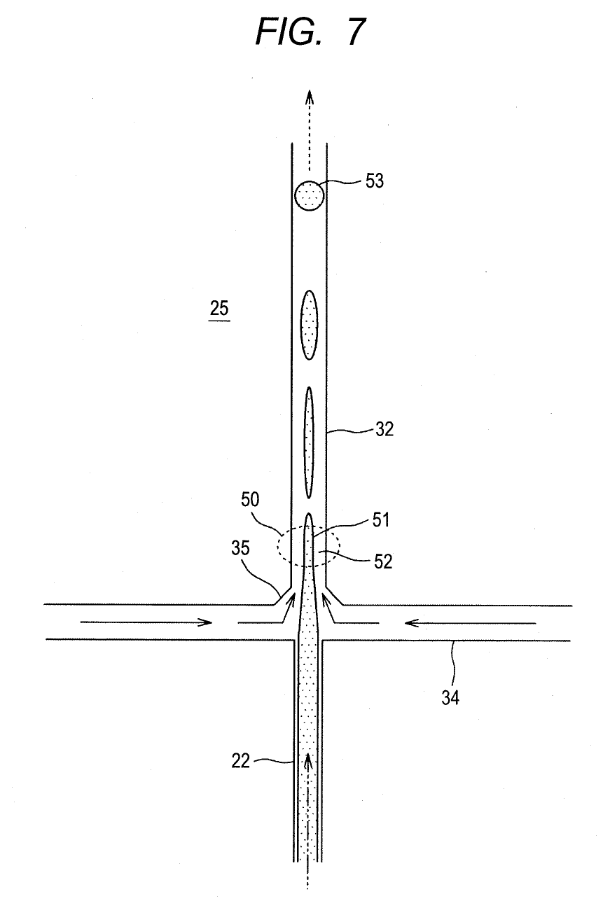

To smoothly merge the continuous phase and the disperse phase and enhance the stability of sheath flow 50 formation, it is more desirable that the inlet of each flow path should be provided with such a chamfered portion 35 as illustrated in FIG. 7. The continuous phase main flow path 31 undertakes a role of a buffer for uniformly supplying liquid to the multiple globule production flow paths 32. Therefore, it is required that it should be a flow path having a sufficiently large section lower in pressure loss than the flow paths obtained by combining the globule production flow paths 32 and the continuous phase processing flow paths 34. For the reason described in relation to the disperse phase distribution portion 20, it is required to make uniform the flow rate of the continuous phase sent to each globule production flow path 32 in order to obtain uniform emulsion. Similarly with the disperse phase main flow path 21, for this purpose, the size of the continuous phase main flow path 31 is determined so that the following is implemented: the flow rate error of the continuous phase flowing into each flow path is suppressed to several % or below according to the following: the number of the globule production flow paths 32, the total flow path resistance of the globule production flow paths 32 and the continuous phase processing flow paths 34, and the like.

Both the end portions 36 of the continuous phase main flow path 31 are wider than the central portion of the flow path as illustrated in the drawing. The reason for this will be described below. As seen from the drawing, both the end portions 36 are in contact with only globule production flow paths 32 equivalent to one row. Therefore, its pressure resistance arising from the combination of the globule production flow paths 32 and the continuous phase processing flow paths 34 is half of that of the central portion in contact with globule production flow paths 32 equivalent to two rows. Therefore, the following problem arises when a constant quantity of liquid is sent from the continuous phase passage opening 24: if both the end portions 36 of the continuous phase main flow path are identical in shape with the central portion, the quantity of liquid sent to the globule production flow paths 32 in contact with either end portion 36 is doubled and the liquid cannot be uniformly sent. To avoid this problem, the continuous phase main flow path is so structured that the width of both the end portions 36 is increased to halve the pressure. Thus liquid can be uniformly sent to all the globule production flow paths 32.

Conversely, the following measure may be taken to make adjustment so as to make uniform the quantity of liquid sent to each globule production flow path 32: the inlet of each continuous phase processing flow path 34 in contact with either end portion 36 is narrowed to increase resistance. Similarly with the disperse phase main flow path 21, the continuous phase main flow path 31 may have any other shape, such as straight shape or spiral shape, as long as the following conditions hold: it is far lower in flow path resistance than the processing flow path portions; it is in the shape of one single consecutive body without a branch at the same level in flow path resistance; and it has a smooth structure without projections or depressions. A disperse phase passage opening 37 open in a position away from the continuous phase main flow path 31 is positioned directly above the disperse phase discharge opening 23. It provides a flow path when liquid discharged from the disperse phase discharge opening 23 is sent to the liquid discharge portion 40.

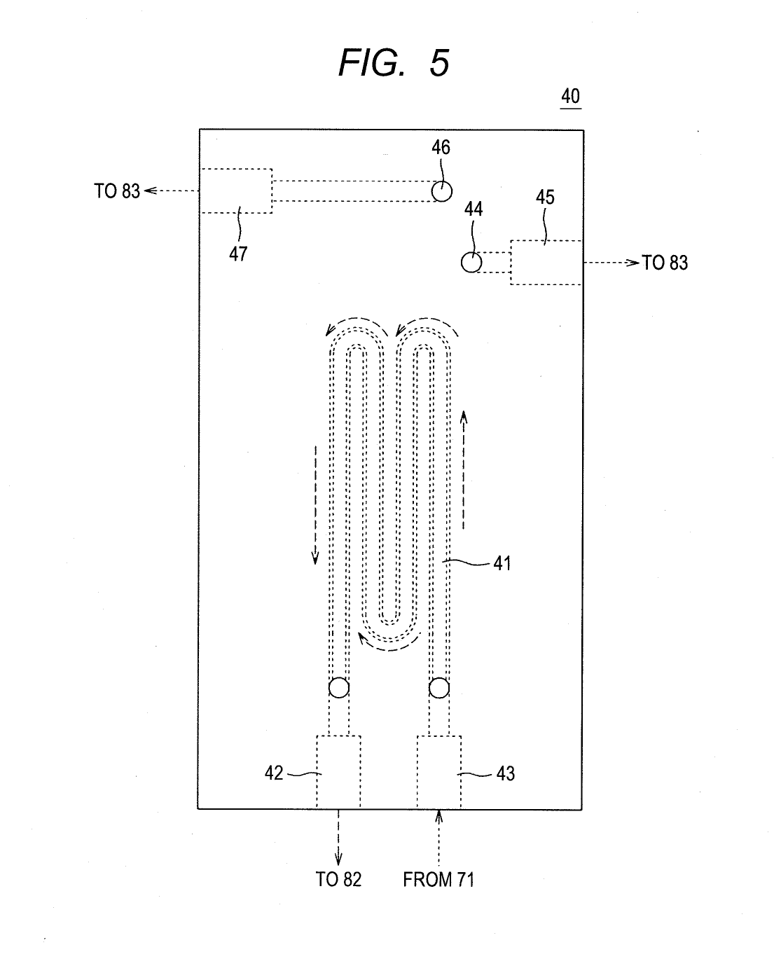

FIG. 5 is a top view of the liquid discharge portion 40. The liquid discharge portion 40 has a meandering emulsion main flow path 41 on the surface (under surface) in contact with the continuous phase distribution portion 30. Both the ends of the emulsion main flow path 41 are connected to an emulsion discharge opening 42 and an emulsion flow path cleaning opening 43 and the emulsion main flow path is formed in a meandering shape so as to cover all the globule production flow paths 32. The produced emulsion discharged from each globule production flow path 32 are merged through the emulsion main flow path 41 and guided to the emulsion discharge opening 42. It is then discharged to outside the microfluidic device 2 for emulsification. To reduce pressure loss in the entire device, it is desirable that the emulsion main flow path 41 should be low in flow path resistance. In this embodiment, its dimensions are made equal to those of the disperse phase main flow path 21.

In addition, the liquid discharge portion 40 includes the following structure to carry out priming and cleaning. The emulsion flow path cleaning opening 43 is provided as an introduction opening for filling the emulsion main flow path 41 with liquid sent from the continuous phase pump 71. A continuous phase discharge port 44 is positioned directly above the continuous phase discharge opening 33 and guides liquid discharged from the continuous phase discharge opening 33 to a continuous phase exhaust opening 45. It then discharges the liquid to outside the microfluidic device 2 for emulsification. A disperse phase discharge port 46 is positioned directly above the disperse phase passage opening 37 and guides liquid passed through the disperse phase passage opening 37 to a disperse phase exhaust opening 47. It then discharges the liquid to outside the microfluidic device 2 for emulsification.

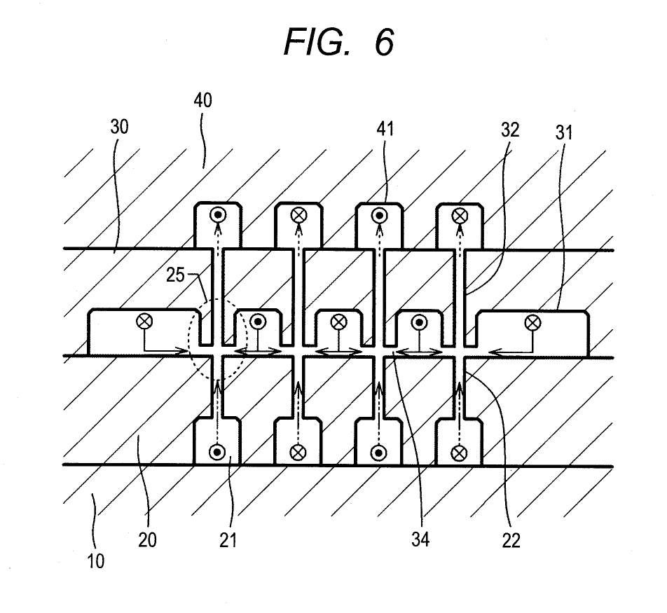

FIG. 6 is an enlarged sectional view taken along line A-A of FIG. 2, illustrating the assembled microfluidic device 2 for emulsification; and FIG. 7 is an enlarged sectional view of the globule production portion encircled with a dotted line and indicated by reference numeral 25 in FIG. 6. The globule production portion 25 is comprised of: a disperse phase processing flow path 22 vertically (upwardly) placed in the disperse phase distribution portion 20 so as to send the disperse phase upward; a continuous phase processing flow path 34 placed in the continuous phase distribution portion so that the continuous phase is horizontally merged into this disperse phase processing flow path 22 from left and right; and a globule production flow path 32 vertically (upwardly) placed in the liquid discharge portion 40 so as to let the merged globules flow upward and send them to the emulsion main flow path 41. In the drawing, the double circle indicates the flow of liquid from the far side to the near side and the circled X indicates the flow of liquid from the near side to the far side. Hereafter, detailed description will be given to priming, emulsion production processing, and flow path cleaning in this embodiment with reference to the above and these drawings.

Prior to the production of emulsion, priming is carried out to remove air in the flow paths and fill the flow paths with liquid. Microfluidic devices using minute flow paths and provided with a large number of flow paths in parallel to increase throughput cannot deliver their performance with air remaining in any flow path. The reason for this is as follows. Since the flow paths are minute, they are prone to be choked with even a very small quantity of residual air. Liquid cannot be sent to a choked area and this exerts harmful influence, for example, the ratio between the continuous phase and the disperse phase is distorted. In minute flow paths, in addition, wall surfaces are high in retaining force because of the ratio of wall surface length/flow path volume and it is difficult to remove air once caught in a flow path. Especially, in such a structure that from some flow path, another flow path having similar flow path resistance is branched, the following takes place: once one flow path is choked with air, liquid easily flows into the unchoked other flow path lower in resistance and this makes it more difficult to remove air. As mentioned above, it is required to reliably carry out priming in microfluidic devices and in this embodiment, the following measure is taken:

In priming, first, the setting of a product/waste liquid change-over valve 82 is turned to the waste liquid tank 95 position and two main flow path opening/closing valves 83 are opened. In this state, the outputs of the pressure sensors 61 are observed and the continuous phase pump 71 and the disperse phase pump 72 are operated at high speed to the extent that the pressure limit of the machine is not exceeded. The liquids of the continuous phase and the disperse phase are thereby sent to the microfluidic device 2 for emulsification. At this time, the continuous phase goes from the continuous phase port 11 to the continuous phase distribution portion 30 by way of the continuous phase passage opening 24 and the like. It thereby pushes out the air in the continuous phase main flow path 31 and fills the main flow path. After the continuous phase fills with main flow path, it goes through the continuous phase discharge opening 33 and moves to outside the microfluidic device 2 for emulsification by way of the continuous phase exhaust opening 45 in the liquid discharge portion 40. It then reaches the waste liquid tank 95 byway of an open main flow path opening/closing valve 83.

The disperse phase goes from the disperse phase port 12 to the disperse phase distribution portion 20 by way of the disperse phase supply opening 14 and the like. It thereby pushes out the air in the disperse phase main flow path 21 and fills the main flow path. After the disperse phase fills the main flow path, it goes through the disperse phased discharge opening 23 and moves to outside the microfluidic device 2 for emulsification by way of the disperse phase exhaust opening 47 in the liquid discharge portion 40. It then reaches the waste liquid tank 95 byway of an open main flow path opening/closing valve 83.

At the first step of priming, as mentioned above, the respective main flow paths 31, 21 for the continuous phase and the disperse phase are filled with the liquids. At this time, the portions of the disperse phase processing flow paths 22 and the globule production flow paths 32 are far higher in flow path resistance than the main flow paths as mentioned above. Therefore, the liquids flows only through the main flow paths. In addition, the main flow paths are in the shape of a smooth meandering consecutive body that does not have a branch at the same level in flow path resistance or projections or depressions. Therefore, the air in the main flow paths does not remain and is exhausted and priming can be reliably carried out.

At the second step of priming, air is removed from minute flow path portions such as the disperse phase processing flow paths 22. After the completion of the above priming of the main flow path portions, the two main flow path opening/closing valves 83 are closed. The liquids of the continuous phase and the disperse phase are sent from the continuous phase pump 71 and the disperse phase pump 72 to the microfluidic device 2 for emulsification. At this time, the flow path resistance of the flow path portions is higher than the resistance of the main flow path portions. Therefore, the outputs of the pressure sensors 61 are observed and the quantities of sent liquids are appropriately adjusted so that the pressure limit of the machine is not exceeded. Since each main flow path is filled with liquid and the main flow path opening/closing valves 83 are closed, the sent continuous phase and disperse phase flow into the minute flow path portions.

More specific description will be given. As illustrated in FIG. 6, the continuous phase enters the continuous phase processing flow paths 34 from two directions, left and right. After merging, it moves upward in the globule production flow paths 32 and passes it through and reaches the emulsion main flow path 41. The disperse phase fills the disperse phase processing flow paths 22 and moves upward. It merges with the continuous phase in the globule production flow paths 32 and moves upward and reaches the emulsion main flow path 41. The liquid that reached the emulsion main flow path 41 is discharged from the emulsion discharge opening 42 to outside the microfluidic device 2 for emulsification. It is then discarded into the waste liquid tank 95 by way of the product/waste liquid change-over valve 82.

At this stage, a structure in which both the liquids of the continuous phase and the disperse phase pass through the flow paths from downward to upward is established and air is easily exhausted. In addition, since the main flow paths fulfill a role of a buffer and liquid can be thereby uniformly sent to the multiple flow path portions, the flow path portions can be reliably primed.

At the final step of priming, air in the emulsion main flow path 41 is removed. As the result of the above-mentioned first and second steps of priming, air is removed from the areas other than the liquid discharge portion 40; however, a small quantity of air may remain in the emulsion main flow path 41. To eliminate a possibility that this air flows back through the globule production flow paths and chokes the flow paths, this portion is primed in the last place. After the completion of the second step of priming, the setting of an outlet flow path change-over valve 84 is turned to the emulsion flow path cleaning opening 43 position and the continuous phase pump 71 is operated. The output of the appropriate pressure sensor 61 is observed and the continuous phase is sent to the extent that the pressure limit of the machine is not exceeded.

The sent continuous phase enters the microfluidic device 2 for emulsification from the emulsion flow path cleaning opening 43 and carries away air and liquid in the emulsion main flow path 41. Thereafter, it is discharged from the emulsion discharge opening 42 to outside the microfluidic device 2 for emulsification and discarded into the waste liquid tank 95 by way of the product/waste liquid change-over valve 82. At this time, the globule production flow paths 32 are far higher in flow path resistance than the emulsion main flow path 41. Therefore, the sent continuous phase flows only through the main flow path and does not flow back to the flow paths. In addition, the main flow path 41 is in a smooth meandering shape without a branch at the same level in flow path resistance or projections or depressions. Therefore, the air in the main flow path does not remain and is exhausted and priming can be reliably carried out.

The air in the microfluidic device 2 for emulsification is removed by carrying out the above-mentioned steps and priming is completed.

Description will be given to emulsion production processing. After the completion of the above-mentioned priming, the setting of the outlet flow path change-over valve 84 is turned to the continuous phase port 11 position. Then the continuous phase and the disperse phase whose sending quantities are so adjusted that an arbitrary globule diameter can be obtained are sent to the microfluidic device 2 for emulsification. The quantity of sent liquid varies depending on the size or number of the disperse phase processing flow paths 22 and the globule production flow path 32, the viscosity of liquid, or the like. Usually, the liquid quantity of a continuous phase is larger than the liquid quantity of a disperse phase and the former is approximately 3 to 10 times the latter in terms of ratio. Until the pumping quantity of each pump is stabilized after start of liquid sending and the liquid in the emulsion main flow path 41 sent during priming is substituted, emulsion not uniform in globule diameter is discharged to outside the microfluidic device 2 for emulsification. Immediately after start of production, for this reason, the setting of the product/waste liquid change-over valve 82 is turned to the waste liquid tank 95 position to discard produced liquid. After the completion of substitution, the setting of the product/waste liquid change-over valve 82 is turned to the product tank 94 position to start the storage of emulsion. If a pump is stopped at this time, the globule diameter of emulsion becomes unstable. To prevent this, the pumps are kept operating and the setting of the product/waste liquid change-over valve 82 is changed. For this reason, it is desirable to provide valves, such as diaphragm valves, excellent in switching response.

The continuous phase and disperse phase sent to the microfluidic device 2 for emulsification are processed as in the above-mentioned priming. Each main flow path 21, 31 is used as a buffer and the processing illustrated in FIG. 6 and FIG. 7 is carried out. That is, the continuous phase is uniformly sent to all the continuous phase processing flow paths 34 from left and right; and the disperse phase is uniformly sent from downward to upward through the disperse phase processing flow paths 22. Then they are merged together and emulsion is formed in the globule production flow paths 32. As illustrated in FIG. 7, the continuous phase processing flow paths 34 are orthogonal to the disperse phase processing flow paths 22. In the process of movement to the globule production flow paths 32, the continuous phase and disperse phase merged in the areas where the flow paths intersect with each other form a sheath flow 50. In this sheath flow, oil as the disperse phase forms a center flow 51 positioned inside and water as the continuous phase forms a covering flow 52 positioned outside.

Since the globule production flow paths 32 are minute flow paths of the order of micrometer, the sheath flow 50 flowing there becomes a stable laminar flow whose Reynolds number is several hundreds or below. Therefore, the two-layer structure in which the continuous phase sheathes the disperse phase can be maintained. As this sheath flow 50 flows through the globule production flow paths 32, the fluctuation of the liquid-liquid interface caused by a difference in the velocity of flow between the continuous phase and the disperse phase is increased. As a result, the disperse phase is divided and an O/W emulsion 53 constant in globule diameter is obtained. The produced O/W emulsion 53 reaches the emulsion main flow path 41 (FIG. 6). Here, the O/W emulsion 53 merges with the emulsion produced at the other globule production flow paths 32 and discharged from the emulsion discharge opening 42 to outside the microfluidic device 2 for emulsification. Then it is stored in the product tank 94 by way of the product/waste liquid change-over valve 82.

The particle diameter of the produced emulsion is influenced by multiple parameters. Such parameters include the diameters of the disperse phase processing flow paths 22 and the globule production flow paths 32, the velocity of flow ratio between the continuous phase and the disperse phase, viscosity, and the like. For example, when the viscosity of the disperse phase becomes higher than conventional, energy required for dividing it is increased. To maintain a certain globule diameter, therefore, it is required to send a larger quantity of the continuous phase. Meanwhile, there is also a method of reducing the diameter of the disperse phase processing flow paths 22 at this time. This makes it possible to maintain the flow rate of the continuous phase and yet maintain the globule diameter. As mentioned above, multiple parameters related to one another are involved in the determination of emulsion particle diameter. The simplest method for controlling particle diameter in this situation is to control the flow rates of the disperse phase and the continuous phase to vary the velocity of flow in a sheath flow. For example, when the flow rate of the disperse phase is fixed and the flow rate of the continuous phase is varied, the following takes place: when the flow rate of the continuous phase is increased, the particle diameter of the produced emulsion is reduced; and when the flow rate of the continuous phase is conversely reduced, the particle diameter is increased. In this embodiment, syringe pumps in which a high pulsating flow is not produced and the pumping quantity is not varied with respect to pressure fluctuation on the secondary side are equipped as the continuous phase pump 71 and the disperse phase pump 72. Then highly accurate flow control is carried out. As a result, precise adjustment of particle diameter can be carried out.

To form a sheath flow 50, it is desirable that the globule production flow paths 32 and the disperse phase processing flow paths 22 should be coaxially located. As mentioned above, this embodiment has the following structure: a structure in which the globule production flow paths 32 are equal to or larger than the disperse phase processing flow paths 22 in size and a chamfered portion 35 is provided at the inlet of each globule production flow path 32. Therefore, even when the axis of each disperse phase processing flow path 22 and that of each globule production flow path 32 become misaligned with each other because of a problem of processing, a sheath flow 50 can be formed to some extent. This enhances the robustness of this embodiment. With respect to the sectional shape of each flow path, a shape without a corner is desirable in consideration of the washing efficiency of the cleaning process described later. Therefore, it is desirable that each corner should be circular or, if rectangular, should be rounded.

In addition, this embodiment adopts a structure in which the disperse phase processing flow paths 22 and the globule production flow path 32 as minute flow paths are open upward. As a result, even when a liquid containing fine particles involving precipitation is used, the precipitate is deposited on the bottom surfaces of the main flow paths 21, 31. Therefore, there is slight precipitate in the minute flow path portions and it is difficult for liquid containing precipitated high-concentration fine particles to flow there. Consequently, the minute flow path portions are not frequently choked with precipitate. Further, even emulsification of a material involving precipitation can be continuously carried out by periodically carrying out the cleaning described later.

Description will be given to cleaning. When emulsion is produced for a long time, there is a possibility that precipitated fine particles or fine dirt in liquid gradually sticks to flow path wall surfaces and accumulates there and the wall surfaces become dirty. In this case, the flow path sectional area is varied in areas where dirt is sticking. This causes the velocity of flow to fluctuate and impairs the uniformity of emulsion globule diameter. If dirt further accumulates, it can choke a flow path. In this case, the production of emulsion itself is impossible. When a liquid containing microminiature solid particles in which precipitation occurs is used, the precipitation of particles is involved and the influence of dirt is more prominent.

One of possible measures against this problem is to clean flow paths before the production of emulsion is harmfully influenced by dirt or precipitation in the flow paths. The simplest method is as follows: the microfluidic device 2 for emulsification is so structured that it can be disassembled and it is dissembled when deposit is removed by ultrasonic cleaning or the like. This method makes it possible to remove dirt without fail; however, it takes some time to disassemble, clean, and reassemble the device and this shortens the operating time of the machine. Therefore, this method is undesirable. In this embodiment, to cope with this, it is made possible to clean all the flow paths by in-line cleaning without disassembling the device.

Cleaning is started on the following occasions: when emulsion production processing has been carried out for an arbitrary certain time; or when information of degradation in globule quality, such as fluctuation in globule diameter, is acquired by the monitoring device 62, illustrated in FIG. 1, that monitors the state of emulsion. When cleaning is started, first, the continuous phase pump 71 and the disperse phase pump 72 are stopped to interrupt pumping of the materials. Subsequently, the setting of the cleaning change-over valves 81 is turned to the cleaning liquid tank position and, in addition, the setting of the product/waste liquid change-over valve 82 is turned to the waste liquid tank 95 position. Then the two main flow path opening/closing valves 83 are opened.

In this state, the continuous phase pump 71 and the disperse phase pump 72 are actuated again to send the cleaning liquids stored in the cleaning liquid tanks 93 are sent to the microfluidic device 2 for emulsification. To enhance the reliability of cleaning, it is desirable to send the cleaning liquids at the maximum allowable pressure of the machine. At each cleaning step described later, therefore, it is desirable to observe the outputs of the pressure sensors 61 and send the liquids at as high velocity as position to the extent that the pressure limit of the machine is not exceeded. Since the continuous phase is aqueous and the disperse phase is oleaginous, two cleaning liquid tanks 93 are provided to respectively send cleaning liquids suitable for them. When a common cleaning liquid is used, the cleaning liquid tanks 93 may be combined into one.

At the first step of cleaning, the continuous phase main flow path 31 and the disperse phase main flow path 21 are cleaned. The cleaning liquids sent to the microfluidic device 2 for emulsification with the valves operated as mentioned above flow as described below. The cleaning liquid for the continuous phase side goes from the continuous phase port 11 to the continuous phase distribution portion 30 by way of the continuous phase passage opening 24 and the like. It carries away the residual liquid, precipitate, and dirt in the continuous phase main flow path 31 and fills the main flow path. The cleaning liquid filled in the main flow path goes through the continuous phase discharge opening 33 and moves to outside the microfluidic device 2 for emulsification by way of the continuous phase exhaust opening 45. Then it reaches the waste liquid tank 95 byway of an open main flow path opening/closing valves 83.

The cleaning liquid for the disperse phase side goes from the disperse phase port 12 to the disperse phase distribution portion 20 by way of the disperse phase supply opening 14 and the like. It carries away the residual liquid, precipitate, and dirt in the disperse phase main flow path 21 and fills the main flow path. The cleaning liquid filled in the main flow path goes through the disperse phase discharge opening 23 and moves to outside the microfluidic device 2 for emulsification by way of the disperse phase exhaust opening 47. Then it reaches the waste liquid tank 95 by way of an open main flow path opening/closing valve 83. At this time, as mentioned above, the portions of the disperse phase processing flow paths 22 and the globule production flow paths 32 are far higher in flow path resistance than the main flow paths; therefore, the cleaning liquids flow only through the main flow paths. In addition, the main flow paths are in a smooth meandering shape without a branch at the same level in flow path resistance or projections or depressions. Therefore, the precipitate or dirt in each main flow path does not remain and is discharged and reliable cleaning can be carried out.

At the second step of cleaning, the minute flow path portions, such as the disperse phase processing flow paths 22 and the globule production flow paths 32, are cleaned. After the completion of cleaning of the main flow path portions, the two main flow path opening/closing valves 83 are closed and the cleaning liquids are sent from the continuous phase pump 71 and the disperse phase pump 72 to the microfluidic device 2 for emulsification. At this time, the flow path resistance of the processing flow path portions is higher than the resistance of the main flow path portions. Therefore, the outputs of the pressure sensors 61 are observed and their pumping quantities are appropriately adjusted so that the pressure limit of the machine is not exceeded. Since each main flow path is filled with cleaning liquid and the main flow path opening/closing valves 83 are closed, the sent cleaning liquids flow to the minute flow path portions.

Specifically, the cleaning liquids flow as illustrated in FIG. 6. That is, the cleaning liquid for the continuous phase side enters the continuous phase processing flow paths 34 from two directions, left and right. After merging, it passes through the globule production flow paths 32 to remove dirt and reaches the emulsion main flow path 41. The cleaning liquid for the disperse phase side removes dirt in the disperse phase processing flow paths 22 and moves upward. It merges with the continuous phase at the globule production flow paths 32 and reaches the emulsion main flow path 41. The liquid that reached the emulsion main flow path 41 is discharged from the emulsion discharge opening 42 to outside the microfluidic device 2 for emulsification and is discarded into the waste liquid tank 95 by way of the product/waste liquid change-over valve 82. At this stage, the main flow paths fulfill a role of a buffer and it is thereby made possible to uniformly send liquid to the multiple flow path portions. Therefore, all the flow path portions can be reliably cleaned.

At the third step of cleaning, the emulsion main flow path 41 is cleaned. After the completion of the above-mentioned second step of cleaning, the setting of the outlet flow path change-over valve 84 is turned to the emulsion flow path cleaning opening 43 position and only the continuous phase pump 71 is operated. Then the output of the appropriate pressure sensor 61 is observed and the cleaning liquid is sent to the extent that the pressure limit of the machine is not exceeded. The sent cleaning liquid enters the microfluidic device 2 for emulsification from the emulsion flow path cleaning opening 43 and carries away the dirt, precipitate, and residual liquid in the emulsion main flow path 41. Then it is discharged from the emulsion discharge opening 42 and discarded into the waste liquid tank 95 by way of the product/waste liquid change-over valve 82. At this time, the globule production flow paths 32 are far higher in flow path resistance than the emulsion main flow path 41; therefore, the sent cleaning liquid flows only through the main flow path and does not flow back to the flow path side. In addition, the main flow path 41 is in a smooth meandering shape without a branch at the same level in flow path resistance or projections or depressions; therefore, the dirt, precipitate, or residual liquid does not remain in the main flow path and they are discharged. Thus cleaning can be reliably carried out.

In the microfluidic device 2 for emulsification in this embodiment, as mentioned above, all the flow paths can be reliably cleaned in a short time without disassembling the device by carrying out cleaning in stages. To further enhance the effect of cleaning, it is desirable that the corners or edges of the flow paths in the device should not be at right angle and should be rounded. In addition, to prevent waste liquid from being caused to flow from the pipe back into the microfluidic device 2 for emulsification, it is desirable to take the following measure: the following pipes are fixed so that they are directed to under the microfluidic device 2 for emulsification and are shortened as much as possible: the pipes between the continuous phase exhaust opening 45 and the corresponding main flow path opening/closing valve 83, between the disperse phase exhaust opening 47 and the corresponding main flow path opening/closing valve 83, and between the emulsion discharge opening 42 and the product/waste liquid change-over valve 82.

To enhance the effect of cleaning when the degree of contamination or precipitation is high, the microfluidic device 2 for emulsification is equipped with an ultrasonic generator 63 (FIG. 1). The effect of cleaning can be further enhanced by actuating it while cleaning liquid is being sent to apply microvibration to the interior of each flow path to lift precipitate and dirt.

As post-cleaning processing, either of the following two is carried out. In case of periodical cleaning during the production of emulsion, the following liquid substitution processing is carried out as the fourth step to resume emulsion production processing: the cleaning liquid in the pipes and the microfluidic device 2 for emulsification is replaced with the continuous phase and the disperse phase. After the completion of the above-mentioned third step of cleaning, the setting of the cleaning change-over valves 81 is turned to the continuous phase tank 91 position and the disperse phase tank 92 position. In addition, the two main flow path opening/closing valves 83 are opened and the setting of the outlet flow path change-over valve 84 is turned to the continuous phase port 11 position. In this state, the continuous phase pump 71 and the disperse phase pump 72 are actuated. The continuous phase and the disperse phase respectively stored in the continuous phase tank 91 and the disperse phase tank 92 are thereby sent to the microfluidic device 2 for emulsification. Similarly with the above-mentioned first step of cleaning, as a result, the cleaning liquids in the continuous phase main flow path 31 and the disperse phase main flow path 21 are replaced with the continuous phase and the disperse phase.

Subsequently, the two main flow path opening/closing valves 83 are closed and the liquids are sent from the continuous phase pump 71 and the disperse phase pump 72 at the pumping quantities for emulsion production processing. As mentioned above, the sent liquid produces emulsion having a desired globule diameter and replaces the cleaning liquid in the minute flow path portions, such as the globule production flow paths 32, and the emulsion main flow path 41. The liquid sending for substitution is continued until it can be determined from an output result from the monitoring device 62 that the emulsion has been brought into a desired state. When the emulsion is stabilized, the substitution is terminated. With liquid sending continued, the setting of the product/waste liquid change-over valve 82 is turned to the product tank 94 position to start the storage of the emulsion. The following can be implemented by periodically carrying out the above-mentioned processing from cleaning to substitution: the internal state of the microfluidic device 2 for emulsification can be refreshed and stable emulsion can be produced for a long time.

As another post-cleaning processing, instead of the above-mentioned substitution processing, residual liquid in the pipes can be removed by air. After the completion of the third step of cleaning, air change-over valves 85 are operated to connect an air source 64 to the piping of the machine. Subsequently, the two main flow path opening/closing valves 83 are opened and the setting of the outlet flow path change-over valve 84 is turned to the continuous phase port 11 position. In this state, high-pressure air is sent from the air source 64 to the microfluidic device 2 for emulsification to the extent that the pressure limit of the machine is not exceeded. As a result, the residual liquid in the continuous phase main flow path 31 and the disperse phase main flow path 21 are purged into the waste liquid tank 95.

Subsequently, the two main flow path opening/closing valves 83 are closed and high-pressure air is sent again. Thus most residual liquid in the minute flow path portions, such as the globule production flow paths 32, and the emulsion main flow path 41 is purged into the waste liquid tank 95. Last, the setting of the outlet flow path change-over valve 84 is turned to the emulsion flow path cleaning opening 43 position and high-pressure air is sent. Thus the residual liquid in the emulsion main flow path 41 is completely purged. As the result of the above processing, the flow paths in the microfluidic device 2 for emulsification are cleaned and residual liquid is removed. This completes the shutdown operation of the machine.

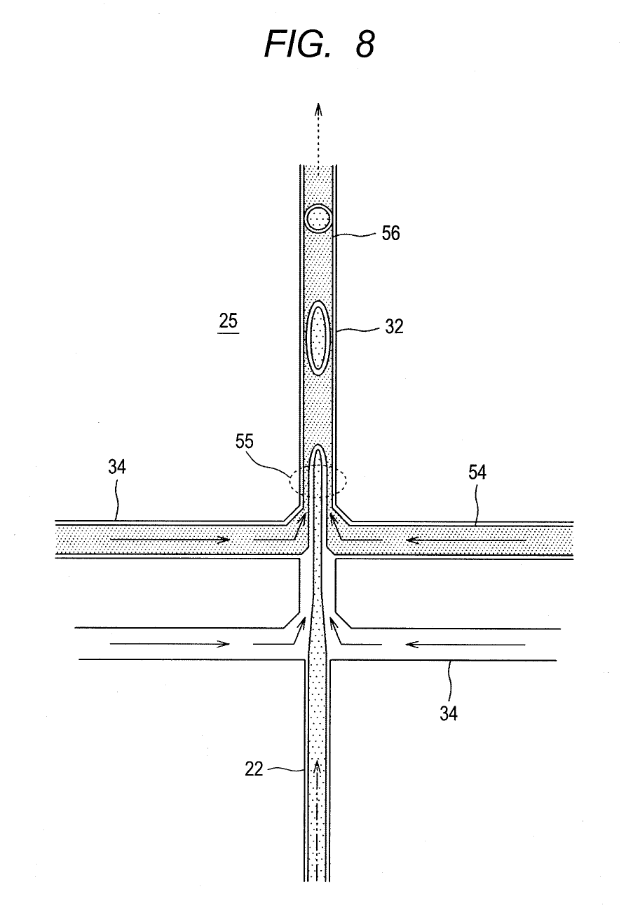

Up to this point, description has been given to an emulsification machine in an embodiment of the invention. In this description, a case where only one processing device is provided has been taken as an example. However, the invention is not limited to this embodiment. In the description of this embodiment, a case where at least two different kinds of liquids are introduced into the processing device has been taken as an example. The number of kinds of introduced liquid may be increased by upsizing the processing device to provide a multiple-stage configuration therein or taking any other like measure. For example, after a sheath flow 50 is formed by this embodiment, the following measure can be taken to produce an O/W/O (oil in water in oil)-type multilayer emulsion 56 as illustrated in FIG. 8: oil is introduced as a second continuous phase 54 to form a three-layer sheath flow 55 in which oil, water, and oil are laminated from the center in this order.

The invention can also be applied to other modes, including a multiple-stage configuration in which multiple processing devices are provided in series and multiple different kinds of continuous phase liquids are sent in stages to produce a multilayer emulsion.

According to the invention, as described up to this point, it is possible to: suppress a minute flow path from being choked by precipitation even when liquid with which precipitation occurs in minute flow paths is used; easily prime and clean flow paths; and stably produce a large quantity of uniform emulsion having an arbitrary particle diameter for a long time.

What is claimed is:

1. An emulsification machine equipped with a microfluidic device that forms a sheath flow in which a continuous phase as a second liquid encircles the circumference of a disperse phase as a first liquid in a flow path and divides and turns the disperse phase into globules by a velocity difference between the disperse phase and the continuous phase to produce an emulsion,
wherein the microfluidic device includes:
a disperse phase main flow path for letting the disperse phase through;
a plurality of disperse phase processing flow paths branched from the disperse phase main flow path and distributing and sending the disperse phase;
a continuous phase main flow path for letting the continuous phase through;
a plurality of continuous phase processing flow paths branched from the disperse phase main flow path and distributing and sending the continuous phase;
a plurality of globule production portions merging together the disperse phase and the continuous phase to produce emulsion globules in areas where the disperse phase processing flow paths and the continuous phase processing flow paths intersect with each other; and
an emulsion main flow path for merging globules produced at the globule production portions and sending the globules to the outside, the emulsification machine further comprising:
pumps respectively provided in a flow path connected to the disperse phase main flow path and a flow path connected to the continuous phase main flow path and pumping liquids flowing through these main flow paths;
main flow path opening/closing valves respectively provided on the discharge opening side of the disperse phase main flow path and the continuous phase main flow path;
a product/waste liquid change-over valve switching liquid sent from the emulsion main flow path between the product side and the waste liquid side;
a monitoring device monitoring the state of emulsion;
pressure sensors respectively monitoring the internal pressures of the disperse phase main flow path and the continuous phase main flow path; and
a control unit controlling the pumps, the main flow path opening/closing valves, and the product/waste liquid change-over valve based on signals form the monitoring device and the pressure sensors.

2. The emulsification machine according to claim 1,
wherein the disperse phase processing flow paths are so disposed as to let the disperse phase flow from downward to upward,
wherein the continuous phase processing flow paths are so disposed that they laterally merge into the disperse phase, and
wherein the globule production portions are provided with globule production flow paths for letting after-merging globules flow upward and sending the same to the emulsion main flow path.

3. The emulsification machine according to claim 2,
wherein the microfluidic device includes:
a disperse phase distribution portion having the disperse phase main flow path and the upward-facing disperse phase processing flow paths branched from the disperse phase main flow path;
a continuous phase distribution portion having the continuous phase main flow path, the laterally-facing continuous phase processing flow paths branched from the continuous phase main flow path, and upward-facing globule production flow paths continuing to the continuous phase processing flow paths; and
a liquid discharge portion having the emulsion main flow path, and
wherein the continuous phase distribution portion is stacked over the disperse phase distribution portion and the liquid discharge portion is stacked thereover.

4. The emulsification machine according to claim 3,
wherein the globule production portions are formed in the area of the stacking of the disperse phase distribution portion and the continuous phase distribution portion, and
wherein the disperse phase processing flow paths, continuous phase processing flow paths, and globule production flow paths are caused to communicate with the globule production portions.

5. The emulsification machine according to claim 2,
wherein the diameter of the after-merging globule production flow paths is equal to or larger than the diameter of the before-merging disperse phase processing flow paths in the globule production portions and the inlet of each of the after-merging globule production flow paths is chamfered into a funnel shape.

6. The emulsification machine according to claim 4,
wherein the diameter of the after-merging globule production flow paths is equal to or larger than the diameter of the before-merging disperse phase processing flow paths in the globule production portions and the inlet of each of the after-merging globule production flow paths is chamfered into a funnel shape.

7. The emulsification machine according to claim 2,
wherein the continuous phase main flow path is formed in such a meandering shape that the disperse phase processing flow paths are sandwiched from both sides so that liquid can be sent from the continuous phase processing flow paths to both the side faces of each of the disperse phase processing flow paths vertically arranged, and
wherein the straight portions of the continuous phase main flow path positioned at both ends in the direction of width are wider than the straight portions thereof positioned in the center in the direction of width.

8. The emulsification machine according to claim 2,
wherein the globule production portions further include second continuous phase processing flow paths intersecting with the globule production flow paths in addition to the continuous phase processing flow paths intersecting with the disperse phase processing flow paths, and
wherein a multilayer sheath flow in which the circumference of a sheath flow formed in the areas of merging of the disperse phase processing flow paths and the continuous phase processing flow paths is encircled with a continuous phase from the second continuous phase processing flow paths is formed to produce a multilayer emulsion.

9. The emulsification machine according to claim 4,
wherein the globule production portions further include second continuous phase processing flow paths intersecting with the globule production flow paths in addition to the continuous phase processing flow paths intersecting with the disperse phase processing flow paths, and
wherein a multilayer sheath flow in which the circumference of a sheath flow formed in the areas of merging of the disperse phase processing flow paths and the continuous phase processing flow paths is encircled with a continuous phase from the second continuous phase processing flow paths is formed to produce a multilayer emulsion.

10. The emulsification machine according to claim 5,
wherein the globule production portions further include second continuous phase processing flow paths intersecting with the globule production flow paths in addition to the continuous phase processing flow paths intersecting with the disperse phase processing flow paths, and
wherein a multilayer sheath flow in which the circumference of a sheath flow formed in the areas of merging of the disperse phase processing flow paths and the continuous phase processing flow paths is encircled with a continuous phase from the second continuous phase processing flow paths is formed to produce a multilayer emulsion.

11. The emulsification machine according to claim 7,
wherein the globule production portions further include second continuous phase processing flow paths intersecting with the globule production flow paths in addition to the continuous phase processing flow paths intersecting with the disperse phase processing flow paths, and
wherein a multilayer sheath flow in which the circumference of a sheath flow formed in the areas of merging of the disperse phase processing flow paths and the continuous phase processing flow paths is encircled with a continuous phase from the second continuous phase processing flow paths is formed to produce a multilayer emulsion.

12. An emulsification method for forming a sheath flow in which a continuous phase as a second liquid encircles the circumference of a disperse phase as a first liquid in a flow path formed in a microfluidic device and dividing and turning the disperse phase into globules by a velocity difference between the disperse phase and the continuous phase to produce an emulsion,
wherein in the microfluidic device, there are formed:
a disperse phase main flow path for letting the disperse phase through;
a plurality of disperse phase processing flow paths branched from the disperse phase main flow path and distributing and sending the disperse phase;
a continuous phase main flow path for letting the continuous phase through;
a plurality of continuous phase processing flow paths branched from the disperse phase main flow path and distributing and sending the continuous phase;
a plurality of globule production portions merging together the disperse phase and the continuous phase in areas where the disperse phase processing flow paths and the continuous phase processing flow paths intersect with each other to produce emulsion globules; and
an emulsion main flow path for merging the globules produced at the globules production portions and sending the globules to the outside,
wherein a flow path connected to the disperse phase main flow path and a flow path connected to the continuous phase main flow path are respectively provided with pumps for pumping liquids flowing therein,
wherein main flow path opening/closing valves are respectively provided on the discharge opening side of the disperse phase main flow path and the continuous phase main flow path,
wherein a product/waste liquid change-over valve is provided on the discharge side of the emulsion main flow path for switching sent liquid between the product side and the waste liquid side, the method comprising:
when priming to remove air in each the flow path and cleaning to remove dirt, such as precipitate, are carried out, opening the main flow path opening/closing valves and turning the setting of the product/waste liquid change-over valve to the waste liquid position;
supplying either the continuous phase, the disperse phase or cleaning liquid to each the main flow path by the pumps,
subsequently, closing the main flow path opening/closing valves and supplying either the continuous phase, the disperse phase or cleaning liquid to the processing flow paths and the globule production portions by the pumps,
subsequently, opening the outlet flow path change-over valve to send the continuous phase, the disperse phase or cleaning liquid to the emulsion main flow path by the pumps; and
thereafter, carrying out emulsification.
